(19) United States
(12) Patent Application Publication
(10) Pub. No.: US 2013/0235264 A1
(43) Pub. Date: Sep. 12, 2013

(54) FLASH BRACKET

(71) Applicants: Joseph M. JOHNSON, SR., San Luis Obispo, CA (US); Matthew L. BURK, San Luis Obispo, CA (US); Joseph M. JOHNSON, JR., San Luis Obispo, CA (US)

(72) Inventors: Joseph M. JOHNSON, SR., San Luis Obispo, CA (US); Matthew L. BURK, San Luis Obispo, CA (US); Joseph M. JOHNSON, JR., San Luis Obispo, CA (US)

(21) Appl. No.: 13/788,402

(22) Filed: Mar. 7, 2013

Related U.S. Application Data
(60) Provisional application No. 61/608,353, filed on Mar. 8, 2012.

(51) Int. Cl. H04N 5/225

(52) U.S. Cl. CPC H04N 5/2254
USPC 348/375

(57) ABSTRACT

A flash bracket comprises three beams each connected to at least one other beam by a hinged joint. The flash bracket can be folded into a compact arrangement with each of the beams abreast an adjacent beam. When deployed and attached to a camera, a flash attached to the flash bracket can be quickly repositioned from a location over the camera's lens for landscape oriented photography to a location over the camera's lens when the camera is rotated ninety degrees for portrait oriented photography.

### CROSS-REFERENCE TO RELATED APPLICATIONS

This applications claims the benefit of Provisional App. No. 61/608,353, filed Mar. 8, 2012.

### BACKGROUND OF THE INVENTION

The present invention relates to a bracket suitable for interconnecting a flash and a camera and, more particularly, to a bracket enabling the relative locations of the flash and the camera to be quickly changed facilitating frequent switching of the camera between the landscape orientation and the portrait orientation.

When taking pictures, photographers frequently change the orientation of the camera between a landscape orientation where the base the camera is substantially horizontal and a portrait orientation where the camera is turned ninety degrees and what would be the base of the camera is substantially vertical. In many cases, the orientation of the camera is changed while using a flash to illuminate the subject. When a camera's base is held horizontally, in the landscape orientation, and the flash is supported on top of the camera, flash based pictures tend to turn out as desired. However, when the same camera is turned ninety degrees to the portrait orientation with the flash extending out to the side from what would be the top of the camera, flash based pictures tend to have an undesirable appearance.

U.S. Pat. No. 3,855,602 shows a camera bracket having a member with a base portion on which a camera can be detachably secured, and a second portion supporting a pivoting arm which, in turn, rotatably supports a member on which a flash attachment may be detachably connected.

U.S. Pat. No. 4,187,021 shows a camera attachment having an elongated base frame with vertical handles at each end and a camera attachment plate centrally located between the handles. A double parallelogram linkage consisting of a pair of inter-parallel links with the links connected to the upper end of one of the handles, a floating swing link, and an outer pair of pivotable links connected to a clamp ring provides support for a flash unit positioned in the clamp ring.

U.S. Pat. No. 4,255,036 shows a support for a camera and a photographic lamp which includes a vertical center section, a horizontal arm extending from the top of the center section to support the lamp, and a pivotal base that supports the camera beneath the lamp.

U.S. Pat. No. 4,291,967 shows an anatomically-shaped hand-grip assembly having a positive locking adjustment capability relative to a base plate to which a camera may be secured, and a positive locking adjustable flash shoe mounted on the top surface of the grip.

U.S. Pat. No. 7,457,535 shows a bracket suitable for mounting a flash comprising a curved arm that extends from the bottom of the camera over the top of the camera. The flash unit is slidable on the arm from a position above the camera to a position at the side of the camera enabling the flash to be located in the desired position above the camera's lens when the camera is in either a landscape orientation or a portrait orientation or an orientation in between.

Event photographers typically shoot in both landscape orientation and portrait orientation and often desire to switch rapidly between orientations. What is desired, therefore, is a compact flash bracket that minimizes the bulk of the photographer's equipment and which enables the flash to be quickly moved from a position favorable for photography with the camera in the landscape orientation to a position favorable for photography with the camera in the portrait orientation.

### BRIEF DESCRIPTION OF THE DRAWINGS

FIG. 1 is an elevation view of a camera with an attached flash bracket and a flash arranged in a desired position for photography in the landscape orientation.

FIG. 2 is an elevation view of the camera, flash bracket and flash of FIG. 1 with the flash arranged in a desired position for portrait orientation photography.

FIG. 3 is a perspective view of the flash bracket of FIGS. 1 and 2 folded for storage.

FIG. 4 is a section view of the first beam of the flash bracket of FIG. 3 taken along line A-A and illustrating engagement with a camera mounted L-plate.

FIG. 5 is a perspective view of an L-plate.

FIG. 6 is a partial section view of the flash bracket taken along line B-B of FIG. 3.

FIG. 7 is a partial section view of the flash bracket taken along line C-C of FIG. 6.

FIG. 8 is a partial section view of the flash bracket taken along line D-D of FIG. 3.

FIG. 9 is a partial perspective of a quick release apparatus including an adapter plate for securing a piece of photographic equipment to the flash bracket.

FIG. 10 is a partial perspective of the quick release apparatus of FIG. 9 illustrating attachment of a piece of photographic equipment to the flash bracket.

### DETAILED DESCRIPTION OF PREFERRED EMBODIMENTS

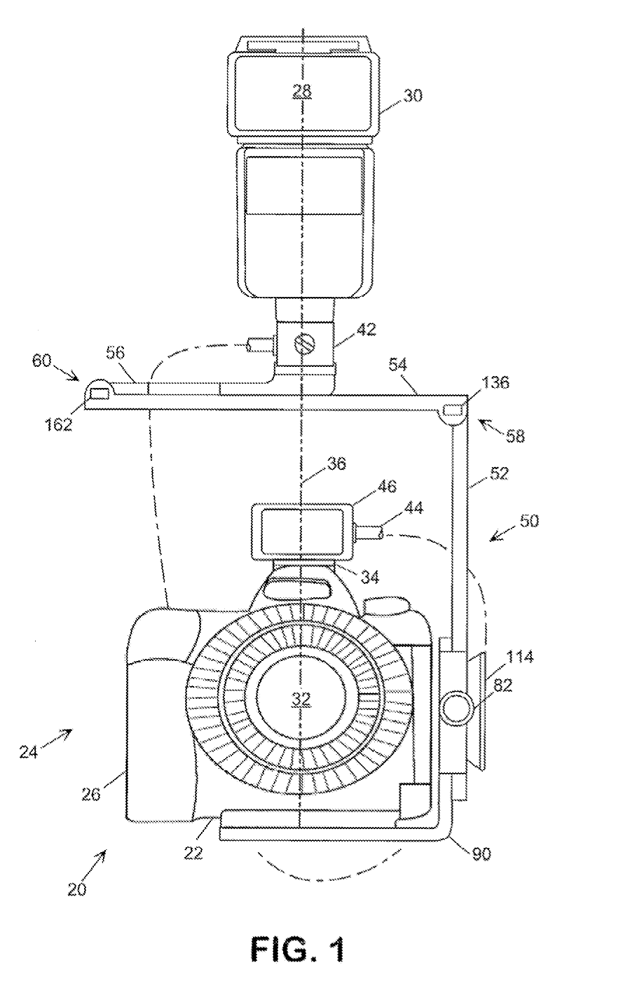

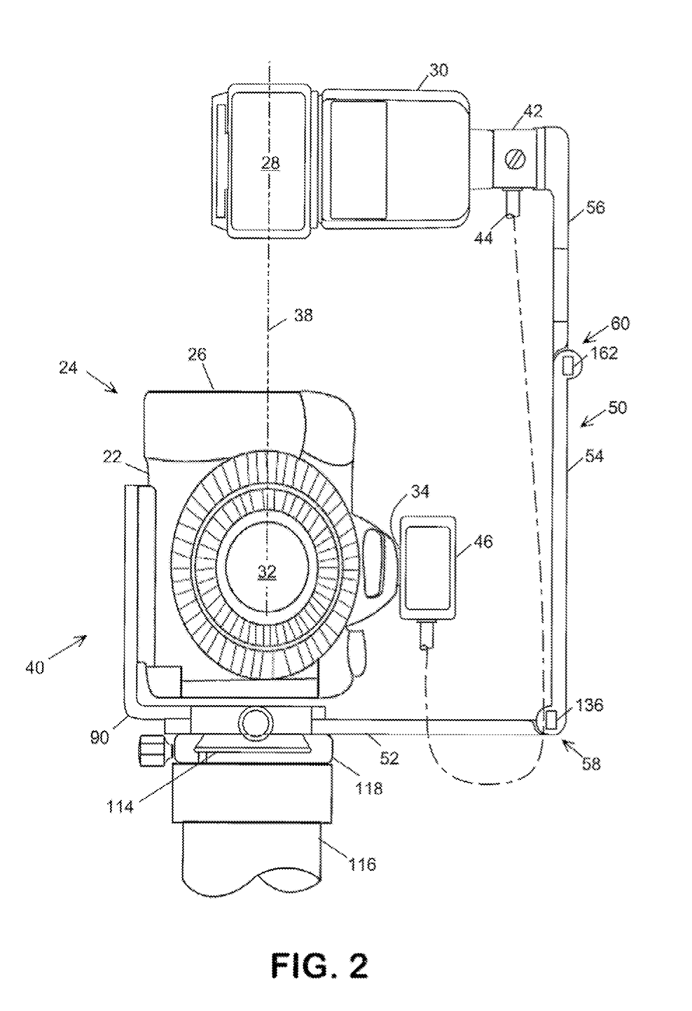

Event photographers often desire to switch frequently and quickly between a landscape orientation where the base of the camera is held substantially horizontal to a portrait orientation with the base of the camera held vertically and vice versa. With a flash mounted on the top of the camera rotating the camera to the portrait orientation places the flash at the side of the lens and produces undesirable effects in the captured images. Referring in detail to the drawings where similar parts are identified by like reference numerals, and, more particularly to FIGS. 1 and 2, when shooting in either the landscape orientation 20 with base 22 of the camera's 24 body 26 aligned substantially horizontal as illustrated in FIG. 1 or in the portrait orientation 40 with the base 22 of the camera's body 26 aligned substantially vertically as illustrated in FIG. 2, it is desirable to have the flash emitter 28 of the flash 30 aligned vertical above the camera's lens 32. If the flash is mounted atop the camera on the shoe 34 the flash will located to the side of the lens when shooting in the portrait orientation which produces some undesirable effects in the captured images. The flash bracket 50 enables the rapid repositioning of the flash so that the flash emitter 28 can be located over the lens 32 on an axis 36 extending through the lens and substantially normal to the base 22 of the camera's body 26 when shooting in a landscape orientation 20 and can be located over the lens on an axis 38 extending through the lens and parallel to the vertical base 22 of the camera when the camera's body 26 is rotated ninety degrees for shooting in the portrait orientation 40.

For illustration purposes, the flash 30 is mounted on an off-camera shoe adapter 42 which is attached to the flash bracket 50 and connected by a cord 44 to a remote unit 46 mounted on the shoe 34 on the top of the camera 24. While an off-camera shoe adapter is common, in some cases the flash may be mounted directly on the flash bracket and operated wirelessly or otherwise without an off-camera shoe adapter.

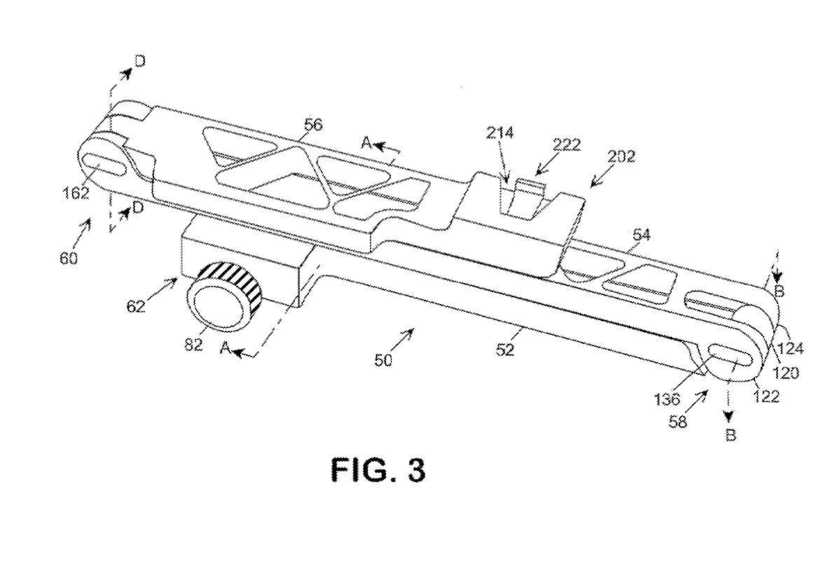

Referring also to FIG. 3, the flash bracket 50 comprises, generally, three beams 52, 54, 56 each having at least one hinged connection with one of the other beams. To reduce the weight of the flash bracket, the beams 52, 54, 56 are each constructed of a light weight material, such as aluminum, and incorporate a lattice structure that reduces the beam's weight while maintaining the rigidity of the beams. The hinged connection 58 which joins the beams 52 and 54 allows the beams to be rotated to a stowed position abreast of each other and the hinged connection 60 which joins the beams 54 and 56 allows the beams to be likewise stowed abreast each other, enabling the flash bracket to be folded into a compact arrangement minimizing the bulk of the bracket for storage and transportation to an event.

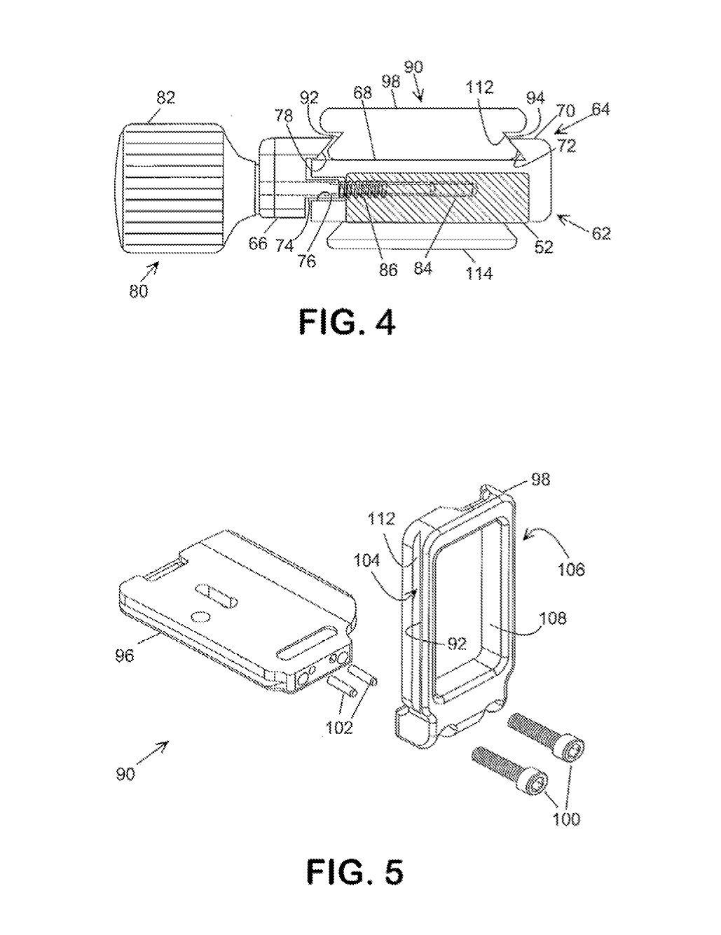

Referring also to FIG. 4, the first beam 52 of the flash bracket 50 includes a bracket securement structure 62 proximate one end of the beam. The bracket securement structure 62 preferably comprises a fixed clamp jaw 64 and movable clamp jaw 66. The fixed clamp jaw 64 comprises a base surface 68 arranged generally parallel to a side 70 of the first beam and a dovetail surface 72 arranged at an angle, for example forty-five degrees, to the base surface 68. The movable clamp jaw 66 includes portions 74 keyed to a conforming portion 76 of the beam to guide the movable clamp jaw in a sliding motion substantially parallel to the base surface 68 of the fixed clamp jaw 64. The movable clamp jaw 66 also includes a dovetail surface 66 which is arranged at an angle to the base surface of the fixed clamp jaw such that the dovetail surfaces of the movable clamp jaw and the fixed clamp jaw form complementary surfaces for engaging a dovetail. A clamp screw 80 engages a threaded aperture 84 defined by portions of the first beam and includes a knob portion 82 that bears against the movable clamp jaw 66. When rotated in a first direction, the clamp screw moves the dovetail surfaces 72, 78 of the bracket securement structure toward each other to clamp a dovetail therebetween and when rotated in the opposite direction the clamp screw allows the dovetail surfaces to be moved away from each other by an elastic member 86 that is compressed between a portion of the first beam and the movable clamp jaw.

To secure the flash bracket 50 to a camera 24, the dovetail surfaces 72, 78 of the bracket securement structure 62 are arranged to engage and clamp complementary dovetail surfaces 92, 94 of an L-shaped plate, commonly referred as an L-plate 90 which is attached to a camera 24. Referring also to FIG. 5, the L-plate 90 comprises a base member 96 which is detachably affixed to the base 22 of the camera and a side member 98 that projects substantially normal to the base member along the side of the camera. The base member 96 is typically detachably affixed to the camera by one or more screws (not shown) which engage threaded apertures in the bottom of the camera. The side member 98 may unitary with the base member or may be separable from the base member and aligned with the base member by dowels 102 and attached to the base member by screws 100 as illustrated in FIG. 5. The side member 98 of the L-plate 90 includes portions defining a pair of side slots 104, 106 on the opposing edges of the side member and may include portions defining a central opening 108 to reduce the weight of L-plate. The outer side, for example surface 92, of each side slot 104, 106 is arranged at an angle to the inner surface 112 of the respective side slot and the slots 104, 106 in the opposing edges of the side member 98 define a dovetail arranged for engagement with the complementary dovetail surfaces 72, 78 of the bracket securement structure 62 of the first beam 52. To secure the flash bracket 50 to the camera 24, the side member 98 of an attached L-plate 90 is inserted between the fixed clamp jaw 64 and movable clamp jaw 66 of the bracket securement structure 62 and the clamp screw 80 is rotated to draw the dovetail surfaces 78, 72 of the clamp jaws together and into clamping engagement with the dovetail defined by the slots 104, 106 in the side member 98 of the L-plate 90.

The first beam 52 of the flash bracket 50 also includes a second dovetail mount 114 on the side of the bracket securement structure that is remote from the fixed and movable clamp jaws 64, 66. The camera assembly may be secured to a tripod or a monopod 116 equipped with a clamp 118 similar to the clamp of the bracket securement structure of the first beam, by engaging and clamping the second dovetail mount 114.

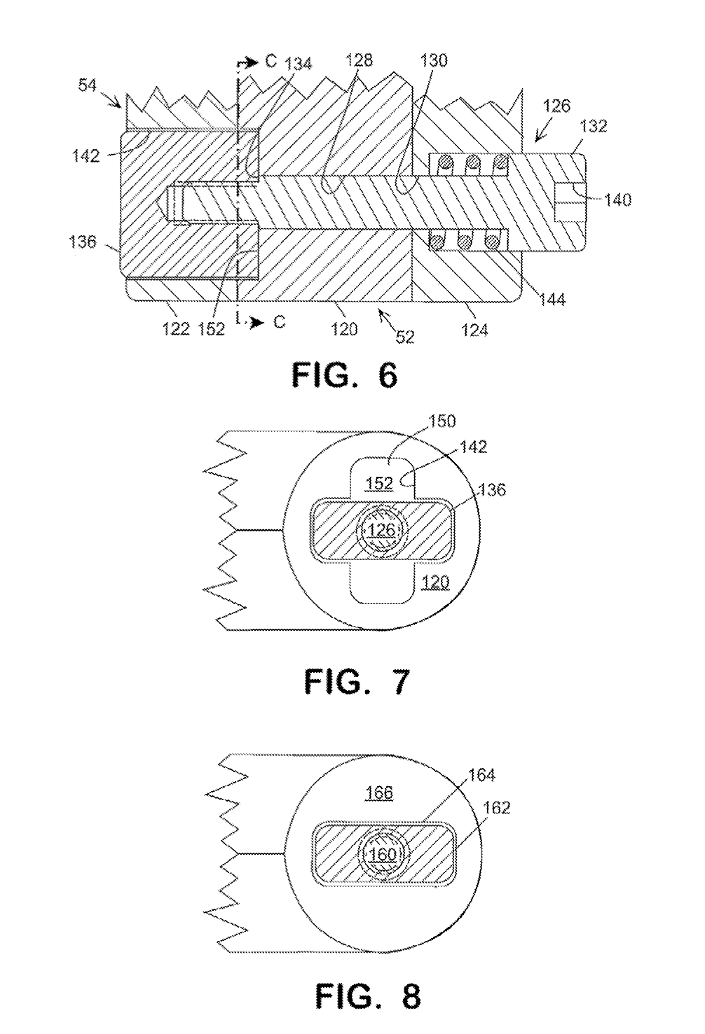

The first beam 52 is hingedly attached 58 to a first end of the second beam 54 at the end of the first beam opposite the bracket securement structure 62. Referring also to FIGS. 6 and 7, the end of the one of the beams, for example, the first beam as illustrated in FIG. 6, includes portions defining a center knuckle 120 for the hinged connection and an end of the other beam, the second beam 54 as illustrated in FIG. 6, includes portions defining a pair of opposed outer knuckles 122, 124 for the hinged connection. A shoulder bolt 126, inserted into concentric bores 128, 130 in the outer and center knuckles, functions as a hinge pin about which the connected beams are rotatable relative to each other.

The shoulder 134 of the shoulder bolt 126 bears on a nut 136 with which the shoulder bolt is in threaded engagement. The head 138 of the shoulder bolt 126 defines a socket 140 for a wrench enabling the shoulder 134 to be securely tightened against the nut 136. The nut 136 has a generally rectangular cross-section and is slidably retained but rotationally constrained in a rectangular aperture 142 in one of the outer knuckles 122. The nut 126 is urged toward the center knuckle 120 by an elastic member 144 that bears on a base surface 146 of a blind cavity 148 defined by portions of the second of the outer knuckles 124 and on the head 138 of the shoulder bolt 126. A portion of the length of the nut 136 is urged toward a base surface 152 of a blind cavity 150 defined by portions of the center knuckle 120 by the action of the elastic member 144. As illustrated in FIG. 7, portions of the center knuckle 120 define a cavity 150 having a wall 142 circumscribing an area having the shape of a cross with lobes approximating the size and shape of a portion of the rectangular end of the nut 136 projecting at each quadrant. When the nut is engaged with the blind cavity in the center knuckle, the interaction between the sides of the portion of the nut projecting into the blind cavity and the wall 142 of the cavity enable the rotational position of the two interconnected beams 52, 54 to be secured at each ninety degree increment of relative rotation.

To rotate the first 52 and second 54 beams relative to each other, the camera user depresses the head 138 of the shoulder bolt 126 which serves as a release button at the hinged juncture of the first 52 and second 54 beams, compressing the elastic member 144 and displacing the nut 136 from the blind cavity 150 in the center knuckle 120. When the portion of the nut 136 that engages the blind cavity 150 in the center knuckle is displaced from the cavity, the user can rotate the beams relative to each and then lock the beams in a new rotational position by releasing the head 138 of the shoulder bolt 126. The elastic member 144 will urge the nut 136 to reengage the blind cavity 150 in the center knuckle where interference between the nut and the wall of the blind cavity. To deploy the second beam 56 in preparation for use, the user depresses the head of the shoulder bolt 126 for the first 52 and second 54 beams and rotates the second beam 270° from its stowed position parallel to the first beam 42 to its deployed position normal to the first beam as illustrated in FIGS. 1 and 2.

The second beam 54 is hingedly attached in a similar manner to the third beam 56 at the end of the second beam distal of its attachment to the first beam 52. As illustrated in FIG. 1, with the second beam 54 rotated to a position normal to the first beam 52 and the third beam 56 abreast the second beam; the flash emitter 28 is in the correct position over the lens 32 for photographing with the camera 24 in the landscape orientation. Referring also to FIG. 8, to position the flash for portrait oriented photography, as illustrated in FIG. 2, the photographer depresses the head of the shoulder bolt 160 at the hinged juncture of the second 54 and third 56 beams displacing the nut 162 from the cavity 164 in the center knuckle 166 and rotates the third beam 180° from the stowed position abreast the second beam to a position linear with the second beam. When the head of the shoulder bolt is released the nut 162 reengages the cavity 164 locking the third beam 56 in position. With the flash 30 projecting normal to the longitudinal axis of the elongate third beam 56 the flash emitter 28 will be correctly positioned over the camera's lens 32 on an axis 38 extending through the lens and parallel to the base 24 for portrait oriented shots. Portions of the center knuckle 166 at the juncture of the second and third beams define a blind cavity 164 having a shape and size approximating the shape and size of the rectangular end of the nut 162. Since the third beam is rotated 180 degrees when switching from the landscape to the portrait orientation, the blind cavity 164 needs only to define a single lobe for the nut 162.

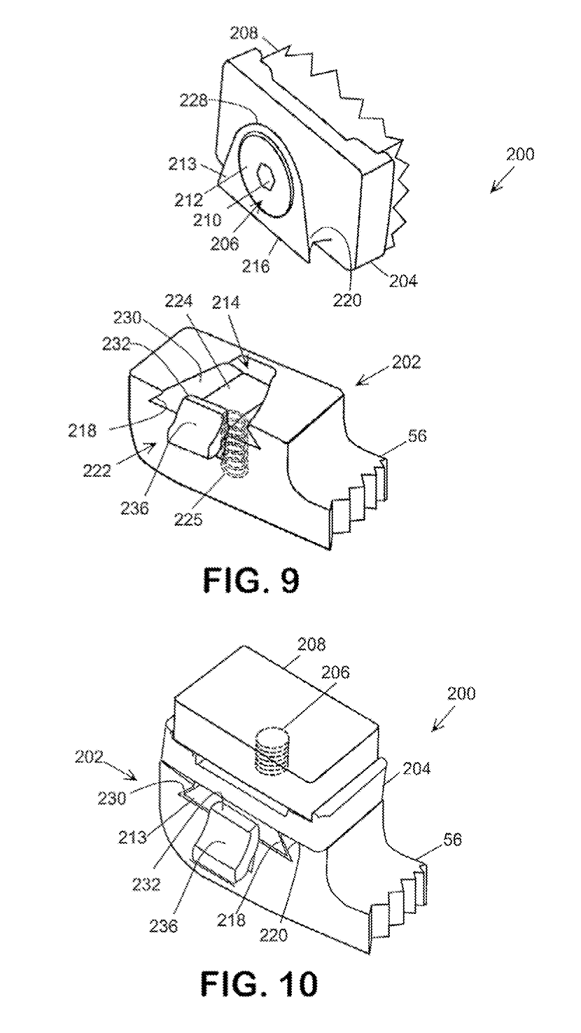

Referring also to FIGS. 9 and 10, the flash 30 is releasably attached to the third beam 56 of the flash bracket 50 by a quick release apparatus 200 which includes an flash securement structure 202 proximate the end of the third beam 56 distal of the third beam's hinged connection to the second beam 54. Solely for illustrative purposes, the camera is depicted as connected by a cord 44 to an off-camera shoe adapter 42 which, in turn, engages the flash 30 and the flash bracket 50 but a flash operable without an off-camera shoe adapter could be releasably attached directly to the flash bracket 50. The quick release apparatus preferably includes an adapter plate 204 which is secured to the second piece of photographic equipment, such as the off-camera shoe adapter 42 which is to be attached to the flash bracket 50, but the second piece of photographic equipment could be manufactured with base portion that is directly engageable with the flash securement structure. The second piece of photographic equipment is secured to the adapter plate 204 by way of a threaded bolt 206 screwed into a threaded bore in the base of the second piece of photographic equipment. The bolt 206 preferably includes a surface defining a socket opening 210 so that a wrench can be used to secure the adapter plate 204 to the second piece of photographic equipment. The end surface 212 of the bolt is also preferably inset into the adapter plate 204. When connected to the second piece of photographic equipment 208 as described above, the adapter plate 204 may be quickly selectively engaged, with the flash securement structure 202 of the third beam 56 of the flash bracket 50, using a single motion due to the structure of the flash securement structure 202 of the third beam and the adapter, respectively.

Specifically, the flash securement structure 202 of the third beam 56 may define a slot 214 into which a flange 216 of the adapter plate 204 may be matingly inserted. Both the flash securement structure 202 and the adapter plate 204 may include structural features designed to matingly and rigidly secure the flange 216 when inserted into the slot 214. One such feature may be respectively beveled peripheral surfaces 218 and 220 around the edges of the slot 214 and the flange 216, respectively, that are opposed to each other when the flange is inserted into the slot. This substantially stabilizes the contact between the flash securement structure 202 and the adapter plate 204 when the latter is fully inserted into the slot, and prevents inadvertent parallel separation of the two members. In addition, the flash securement structure 202 may include a locking mechanism 222 having a spring-loaded latch arm 224 that automatically locks the flange 216 of the adapter plate 204 into the slot 214 when the flange moves from a position incrementally prior to full insertion into the slot to a position of full insertion into the slot. Specifically, the peripheral edges 218 and 220 of the slot 214 and flange 216, respectively, are each inwardly tapered in the direction of insertion of the flange 216 into the slot 214. This permits the leading edge 228 of the flange 216 to be inserted into the interior of the slot 214 without precisely aligning the flange and the slot or with the bottom surface of the flange at an angle to the bottom surface of the slot 214. As the motion of inserting the flange 216 into the slot 214 continues, the engagement of the peripheral edges 218, 220 causes the angle between the surfaces 213 and 230 to diminish, thereby pushing the latch arm 224 downwards, compressing a spring 225, until a position of locked engagement between the flash securement structure 202 and the adapter plate 204 is reached. Contact between the latch arm 224 and the bottom surface 213 of the flange 216 ends, and the spring 225 causes the latch arm 224 to move upward toward its original position. When the latch arm 224 returns to approximately its original position, a tab portion 232 of the latch arm 224 extends past the bottom surface 213 of the flange 216 to lock the adapter plate 204 to the flash securement structure 202 of the third beam 56. When it is desired to release the flange 216 from the slot 214, the latch arm 224 may be manually depressed to compress the spring 225 until the tab portion 232 is flush with the bottom surface 213 of the flange 216, permitting the flange to slide laterally in the slot 214, releasing the off-camera flash adapter or other attachment photographic equipment from the third beam 56 of the flash bracket 50. The tab portion 232 of the latch arm may include a depression 236 to facilitate manual depression of the latch arm 224 using a thumb or another digit.

To use the flash bracket 50, the user engages the bracket securement structure 62 with an L-plate 90 attached to the base 22 of the body 26 of the camera 24. The bracket securement structure 62 of the flash bracket is engaged with the L-plate and the fixed 64 and movable clamp jaws 66 are tightened on the dovetail formed by the slots in the L-plate. The second beam 54 is freed for rotation relative to the first beam 52 by depressing the head of the shoulder bolt at the hinged joint connecting the first beam and the second beam. Rotating the second beam 270° and releasing the head of the shoulder bolt locks the second beam in the deployed position. Installing the flash 30 with the quick release apparatus 200 and making the required wiring connections to the camera readies the camera for capturing images in the landscape orientation with the flash emitter located on an axis extending perpendicular to the camera's base and through the lens. To switch to the portrait orientation, the user depresses the head of the shoulder bolt at the juncture of the second and third beams and rotates the third beam from its stowed position abreast the second beam to a linear position with the longitudinal axes of the second and third beams substantially parallel and substantially end-to-end. Releasing the head of the shoulder bolt 160 locks the relative rotation of the second and third beams with the flash emitter on an axis that extends through the camera's lens and substantially parallel to the base of the camera. When the camera is turned 90° from the landscape to the portrait orientation, the flash will be advantageously located above the lens.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A bracket for interconnecting a flash including a flash emitter and a camera comprising a lens and a body having a base, said bracket comprising:
(a) a first bracket portion arranged for detachable interconnection with said camera; and
(c) a second bracket portion including a securement structure enabling detachable interconnection of said second bracket portion and said flash, said second bracket portion hingedly attached to said first bracket portion and rotatable from a first position in which said flash emitter is arranged on an axis extending substantially normal to said base and through said lens to a second position in which said flash emitter is arranged on an axis extending substantially parallel to said base and through said lens.

2. The bracket for interconnecting a camera and a flash of claim 1 further comprising a lock structure arranged to releasably secure rotation of said second bracket portion in the ones of said first position and said second position.

3. The bracket for interconnecting a camera and a flash of claim 1 wherein said first bracket portion comprises:
(a) an elongate first beam; and
(b) an elongate second beam hingedly attached to said first beam and rotatable from a stowed position abreast said first beam to a deployed position normal to said first beam.

4. The bracket for interconnecting a camera and a flash of claim 3 further comprising a lock structure arranged to releasably secure rotation of said second beam in the ones of said stowed position and said deployed position.

5. The bracket for interconnecting a camera and a flash of claim 4 further comprising a lock structure arranged to releasably secure rotation of said second bracket portion in the ones of said first position and said second position.

6. The bracket for interconnecting a camera and a flash of claim 3 wherein said second bracket portion is arranged abreast of said second beam in said first position.

7. The bracket for interconnecting a camera and a flash of claim 6 further comprising a lock structure arranged to releasably secure rotation of said second bracket portion in the ones of said first position and said second position.

8. The bracket for interconnecting a camera and a flash of claim 1 wherein said first bracket portion comprises:
(a) an elongate first beam including a fixed clamp jaw surface;
(b) a movable clamp jaw slidably secured to said first beam and movable in a first direction away from said fixed clamp jaw surface and movable in a second direction toward said fixed clamp jaw surface to engage and secure therebetween a mounting plate affixed to said body of said camera; and
(c) an elongate second beam hingedly attached to said first beam and rotatable from a stowed position abreast said first beam to a deployed position normal to said first beam.

9. The bracket for interconnecting a camera and a flash of claim 8 further comprising a screw in threaded engagement with said first beam and including a portion bearing on said movable clamp jaw, rotation of said screw in a first direction moving said movable clamp jaw away from said fixed clamp jaw surface and rotation of said screw in a second direction moving said movable clamp jaw toward said fixed clamp jaw surface.

10. A bracket for interconnecting a flash including a flash emitter and a camera comprising a lens and a body having a base, said bracket comprising:
(a) an elongate first beam arranged for detachable interconnection with said body of said camera;
(b) an elongate second beam hingedly attached to said first beam and rotatable from a stowed position abreast said first beam to a deployed position normal to said first beam;
(c) a first lock structure arranged to releasably secure rotation of said second beam in the ones of said stowed position and said deployed position;
(d) an elongate third beam including a securement structure enabling detachable interconnection of said third beam with said flash, said third beam hingedly attached to said second beam and rotatable from a folded position abreast said second beam to an unfolded position substantially linear with said second beam; and
(e) a second lock structure arranged to releasably secure rotation of said third beam in the ones of said folded position and said unfolded position.

11. The bracket for interconnecting a camera and a flash of claim 10 further comprising:
(a) a fixed clamp jaw surface of said first beam; and
(b) a movable clamp jaw slidably secured to said first beam and movable in a first direction away from said fixed clamp jaw surface and movable in a second direction toward said fixed clamp jaw surface to engage and secure therebetween a mounting plate affixed to said body of said camera.

12. The bracket for interconnecting a camera and a flash of claim 11 further comprising a screw in threaded engagement with said first beam and including a portion bearing on said movable clamp jaw, rotation of said screw in a first direction moving said movable clamp jaw away from said fixed clamp jaw surface and rotation of said screw in a second direction moving said movable clamp jaw toward said fixed clamp jaw surface.

13. The bracket for interconnecting a camera and a flash of claim 11 further comprising a spring bearing on said first beam and on said movable clamp jaw, said spring urging said movable clamp jaw away from said fixed clamp jaw surface.

14. The bracket for interconnecting a camera and a flash of claim 11 wherein said fixed clamp jaw and a surface of said movable clamp jaw are arranged at an angle to engage plural dovetail surfaces of said mounting plate.

15. A bracket for interconnecting a flash including a flash emitter and a camera comprising a lens and a body having a base, said bracket comprising:
(a) an elongate first beam including a bracket securement structure arranged to interconnect said first beam and said base of said camera's body;
(b) an elongate second beam hingedly attached to said first beam and rotatable from a stowed position abreast said first beam to a deployed position normal to said first beam;
(c) a first lock structure arranged to releasably secure rotation of said second beam in the ones of said stowed position and said deployed position;
(d) an elongate third beam including a flash securement structure arranged to detachably interconnect of said third beam with said flash, said third beam hingedly attached to said second beam and rotatable from a folded position to an unfolded position, an axis normal to said base and extending through said lens intersecting said flash emitter of said attached flash when said second beam is in said deployed position and said third beam is in said folded position and an axis parallel to said base and extending through said lens intersecting said flash emitter when said second beam is in said deployed position and said third beam is in said unfolded position; and
(e) a second lock structure arranged to releasably secure said third beam in the ones of said folded position and said unfolded position.
